(19) United States
(12) Patent Application Publication
(10) Pub. No.: US 2025/0362849 A1
(43) Pub. Date: Nov. 27, 2025

(54) TEST PRINTING USING SUPPORT PROGRAM IN ASSOCIATION WITH UNIVERSAL PRINTING PROGRAM

(71) Applicant: BROTHER KOGYO KABUSHIKI KAISHA, Nagoya (JP)

(72) Inventors: Yoshito HOSOMIZO, Konan (JP); Kenju NARITA, Nagoya (JP); Yushi ICHIKAWA, Nagoya (JP); Airi EGUCHI, Ichinomiya (JP)

(21) Appl. No.: 19/290,976

(22) Filed: Aug. 5, 2025

Related U.S. Application Data
(63) Continuation of application No. PCT/JP2024/003450, filed on Feb. 2, 2024.

(30) Foreign Application Priority Data
Feb. 8, 2023 (JP) 2023-017410

(51) Int. Cl. G06F 3/12; G06F 3/0482

(52) U.S. Cl. CPC G06F 3/1256; G06F 3/0482; G06F 3/1258; G06F 3/1297

(57) ABSTRACT

A computer with a support program performs processes of displaying a settings screen, receiving a test-print setting via the settings screen, receiving a test print execution instruction via the settings screen, generating test-print image data based on the test-print setting, transmitting the test-print image data for printing, receiving a print instruction from a universal printing program, receiving intermediate image data from the universal printing program, generating print image data based on the intermediate image data using a print setting, and transmitting the print image data for printing.

### REFERENCE TO RELATED APPLICATIONS

This is a continuation application of International Application No. PCT/JP2024/003450 filed Feb. 2, 2024, that claims priority from Japanese Patent Application No. 2023-017410 filed Feb. 8, 2023. The entire contents of the aforementioned applications are incorporated herein by reference.

### BACKGROUND ART

As a technique for controlling a printer via an information processing apparatus such as a personal computer, disclosed is a configuration in which a printer driver provided by a printer manufacturer receives print settings that distinguishes test printing from normal printing, and when a print instruction for test printing is given, data to be printed is read out to generate a print job for test printing.

In recent years, a technique for controlling a printer by an OS-standard universal printing program that is a part of an operating system (OS) without using a printer driver provided by a printer manufacturer has been put into practical use. In this technique, when the OS detects a printer, the printer is associated with the OS-standard universal printing program, and when a print instruction for the printer is subsequently received, the OS-standard universal printing program generates print data without using a printer driver provided by the printer manufacturer, so that printing by the OS-standard universal printing program is available.

### SUMMARY

The above-described OS-standard universal printing program has only a minimal test printing function and does not have a test printing function for advanced print settings as provided in printer drivers provided by printer manufacturers. Therefore, in order to change color balance such as brightness, contrast, or saturation in print settings, it is required to repeat opening a settings screen, changing print settings, and inputting a print instruction, which causes inconvenience to the user.

A support program disclosed in the present specification accepts print settings and test print execution instructions via a setting screen. When a test print execution instruction is issued in a state where a specific parameter is accepted, the support program causes a printer to print a test image processed based on the specific parameter. Thus, an information processing apparatus in which an OS-standard universal printing program is installed, and a printer driver provided by a printer manufacturer is not installed executes test printing reflecting the print settings accepted on the setting screen. Therefore, the effort of test printing is less than that in the case where changing the print settings and printing are repeated.

According to a technology disclosed in the present specification, print settings for test printing are easily managed in an information processing apparatus with an OS-standard universal printing program.

### BRIEF DESCRIPTION OF DRAWINGS

FIG. 1 is a block diagram schematically showing an electrical configuration of a PC.

FIG. 2 is a sequence diagram illustrating an example of print settings procedure.

FIG. 3 is an explanatory view showing an example of a print settings screen.

FIG. 4 is an explanatory view showing an example of a custom settings screen.

FIG. 5 is a sequence diagram illustrating an example of test printing procedure.

FIG. 6 is a sequence diagram illustrating an example of print execution procedure.

### DESCRIPTION

A personal computer (PC) executing a support program, e.g., a supporting program, of the present embodiment will be described in detail below with reference to accompanying drawings.

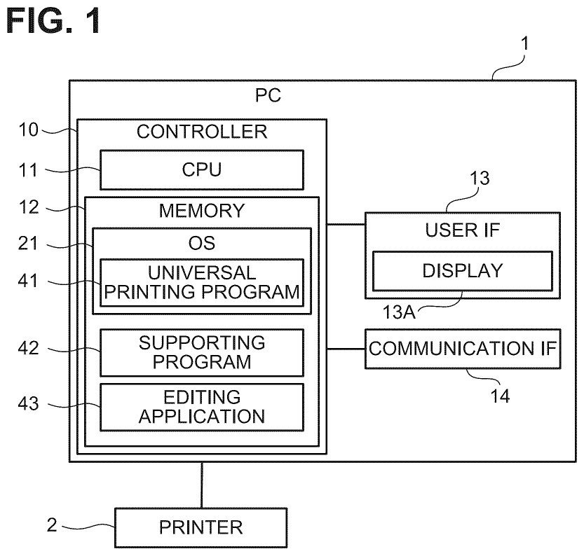

As shown in FIG. 1, a PC 1 of the present embodiment includes a controller 10 including a CPU 11 and a memory 12. The PC 1 is an example of an information processing apparatus. The CPU 11 is an example of a computer. The PC 1 also includes a user interface (user IF) 13 and a communication interface (communication IF) 14, which are electrically connected to the controller 10. The controller 10 may represent hardware and software for controlling the PC 1, and may not be limited to a single hardware in the PC1.

The CPU 11 of the PC 1 executes various processes according to programs read from the memory 12 and based on user operations. The memory 12 stores various programs and various data. The memory 12 may also be used as a work area while various processes are executed. A buffer provided in the CPU 11 may also be an example of a memory. An example of the memory 12 may not be limited to a known ROM, RAM, HDD, or the like built in the PC1, and may be a storage medium, such as a CD-ROM or a DVD-ROM, that can be readable and/or rewritable by the CPU 11.

The user IF 13 includes a display 13A for displaying a screen to notify a user of information, and hardware for receiving an operation by a user. The user IF 13 may be a combination of the display 13A and a mouse, a keyboard, or the like having a function for receiving user input, or may be a touchscreen having a function for both displaying information and receiving input.

The communication IF 14 includes hardware for communicating with an external device such as a printer 2. The communication IF 14 may follow a communication standard, such as Ethernet, Wi-Fi, or USB. The PC 1 may be communicable to the Internet via the communication IF 14. The PC 1 may include a plurality of communication IFs 14, each corresponding to a particular communication standard.

As shown in FIG. 1, the memory 12 of the PC 1 stores various programs and various data, including an operating system (OS) 21 including a universal printing program 41, a supporting program 42, and an editing application 43. The supporting program 42 is an example of a support program. The editing application 43 is an example of an application program. The supporting program 42 is configured for various processes in association with the universal printing program 41.

The OS 21 is a multi-task OS capable of managing multiple tasks and switch the tasks to process the multiple tasks concurrently. Examples of the OS 21 may include, but not be limited to, Windows, macOS, Linux, iOS, and Android.

The OS 21 includes a universal printing program 41. The universal printing program 41 is an OS-standard printing program provided by a supplier of the OS 21 and is a part of the OS 21. The universal printing program 41 is not configured to launch a printer driver unique to each printer.

The universal printing program 41 has functions of causing any printers provided by various manufacturers to execute printing based on user instructions. The universal printing program 41 supports a general-purpose function that can be executed for printing at various printers. The universal printing program 41 does not support a specific function, that may require complex processing, as provided for each printer or its printer driver.

The universal printing program 41 also has functions of receiving image data output from various applications and generating intermediate image data based on the image data. The intermediate image data may be in XML Paper Specification (XPS) format. The universal printing program 41 further has functions of generating print data in a format for printing based on the intermediate image data. The print data may be bitmap data in PWG Raster format or PDF data. The universal printing program 41 further has functions of transmitting the generated print data to a designated printer via a communication function of the OS 21.

The supporting program 42 is provided by a manufacturer of the printer 2. The supporting program 42 may be a program or a group of programs for executing processing based on an instruction from the OS 21 in association with processing of the universal printing program 41, and for supporting control of the printer 2. The universal printing program 41 launches the supporting program 42 when the printer 2 is selected as a device for printing, when an instruction for advanced print settings is received after the printer 2 is selected, or when an instruction to cause the printer 2 to perform printing is received. The supporting program 42 may be a print support application (PSA) or a hardware support application (HSA).

The supporting program 42 may be a combination of programs each of which receives an execution instruction, or may be a single program which can execute various processing according to an instruction. The supporting program may be provided for each printer by a printer manufacturer. For example, a supporting program for an inkjet printer may be provided. Another supporting program for a laser printer may be separately provided. The supporting program may be provided for each printer model or each printer model series, instead of each printer.

When a new printer is connected to the PC 1, the OS 21 may download an appropriate supporting program from a data server of a printer manufacturer and install the supporting program into the PC 1. The OS 21 stores identification information of the installed supporting program in the memory 12 in association with printer information of the newly connected printer.

The editing application 43 is an application program for creating and editing image data and text data. The editing application 43 may be Microsoft Word, Microsoft PowerPoint, or a program provided by a manufacturer of the printer 2. The editing application 43 may receive a print instruction via the user IF 13 for causing the printer 2 to perform printing. The editing application 43 may not be limited to a program for creating and editing image data, and may be a program having a function of receiving a display instruction or a print instruction for various information such as map data and web pages in response to a user request.

The PC 1 of this embodiment is connected to a printer 2 via the communication IF 14 as shown in FIG. 1. The printer 2 has a printing function and a communication function. When the printer 2 receives print data from the PC 1, the printer 2 performs printing based on the received print data. In this embodiment, the printer 2 is capable of color printing.

An operation procedure for printing related to the PC 1 will be described with reference to a sequence diagram. Each process in the present embodiment basically indicates a process of the CPU 11 according to an instruction described in a program such as the supporting program 42. The process by the CPU 11 may include control of hardware using an Application Programming Interface (API) of the OS 21. In the present specification, the operation of each program may be described without detailing the OS 21.

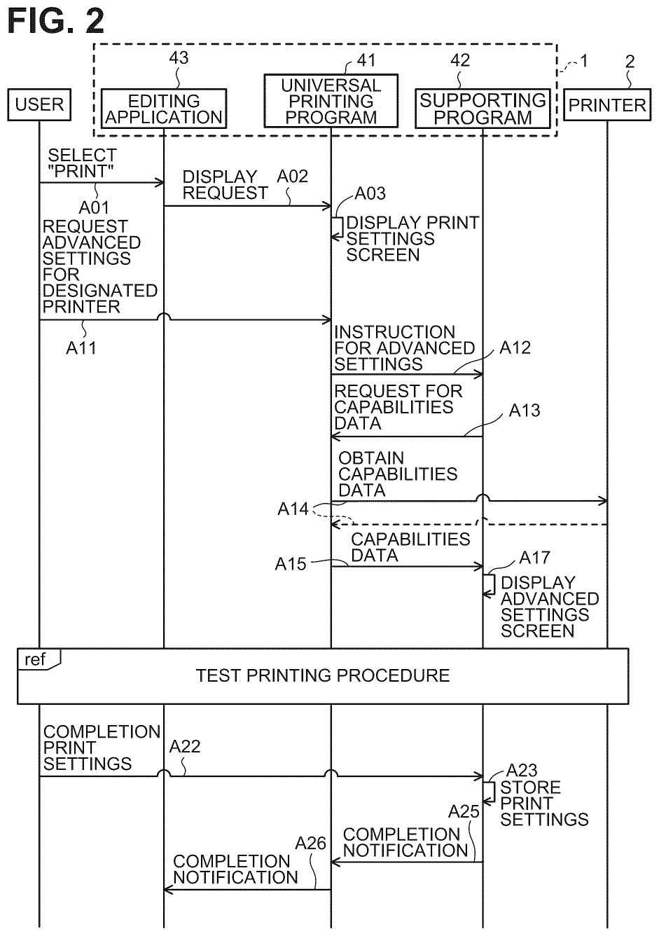

A print settings procedure will be described with reference to a sequence diagram of FIG. 2. The editing application 43 receives creating and editing a text or an image based on a user instruction. The user may select “printing” from a menu screen via the editing application 43 (A01) for printing the text or the image.

Upon receiving the selection of printing, the editing application 43 requests the universal printing program 41 to display a screen for receiving an instruction relating to printing (A02). The universal printing program 41 causes the user IF 13 to display a print settings screen in response to the request (A03). The print settings screen is a screen for receiving an instruction from the user for various print settings that can be processed by the universal printing program 41. The editing application 43, instead of the universal printing program 41, may display the print settings screen.

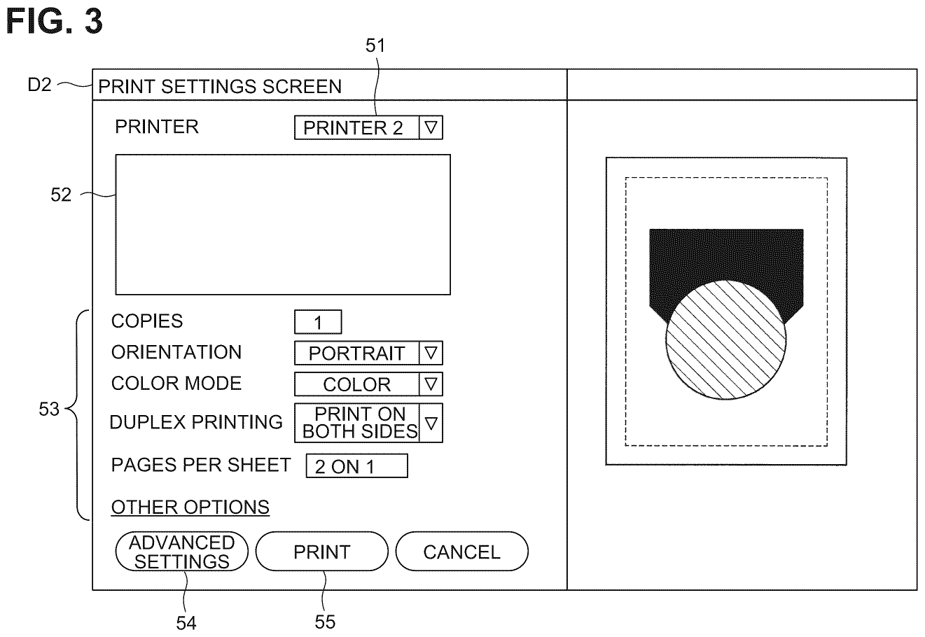

An example of the print settings screen is shown in FIG. 3. The print settings screen D2 includes a printer selection field 51, an information display field 52, a selection field 53 for basic print settings, an advanced settings button 54, and a print button 55. The printer selection field 51 is a field for receiving a selection of a printer. The information display field 52 is a field for displaying information designated by the supporting program 42 corresponding to a printer selected in the printer selection field 51. When the printer selection field 51 receives a selection of the printer 2, or when the OS 21 receives a print instruction after the printer 2 is set as a default printer, the universal printing program 41 launches the supporting program 42 and display an image from the supporting program 42 in the information display field 52.

The selection field 53 is a field for receiving basic settings such as the number of copies to be printed and printing orientation. The advanced settings button 54 is a button for receiving an instruction for advanced settings not included in the basic print settings. The print button 55 is a button for receiving an instruction for executing printing in the selected print settings.

When the printer 2 is selected in the printer selection field 51 and an instruction for advanced print settings is received at the advanced settings button 54 (A11), the universal printing program 41 passes an instruction to the supporting program 42 to start receiving the advanced print settings (A12).

The supporting program 42 is launched in response to the instruction in A12, and then obtains capabilities data of the printer 2. Specifically, the supporting program 42 requests the universal printing program 41 for the capabilities data (A13). The universal printing program 41 transmits a command requesting the capabilities data to the printer 2 (A14). The universal printing program 41 passes the obtained capabilities data to the supporting program 42 (A15). In this way, the supporting program 42 obtains capabilities data of the printer 2.

The universal printing program 41 communicates with the printer 2 in A14 via the OS 21 according to Internet Printing Protocol (IPP). The supporting program 42 may directly obtain the capabilities data from the printer 2 by using Management Information Base (MIB), instead of requesting the universal printing program 41 for the capabilities data.

The capabilities data obtained from the printer 2 includes parameters that can be set as print settings. The capabilities data may further include a remaining amount of consumables, selectable sheet trays, sheet information in each sheet tray, and available print resolutions. The printer 2 may have a function of consolidated printing such as N up printing, compositing printing such as watermark printing, and saving printing for saving coloring agents. All of those functions are additional image processing based on a received print job for printing images after the additional image processing. The printer 2 may pass capabilities data including information on those functions. The capabilities data may also include status information of the printer 2.

The supporting program 42 causes the user IF 13 to display an advanced settings screen for receiving advanced print settings based on the obtained capabilities data (A17). The advanced settings screen includes parameters related to the capabilities data of the printer 2. The supporting program 42 receives a user operation to the advanced settings screen. Since many advanced print settings may be set on the advanced settings screen, the supporting program 42 may display tabs and receive instructions to designate different print settings in each tab.

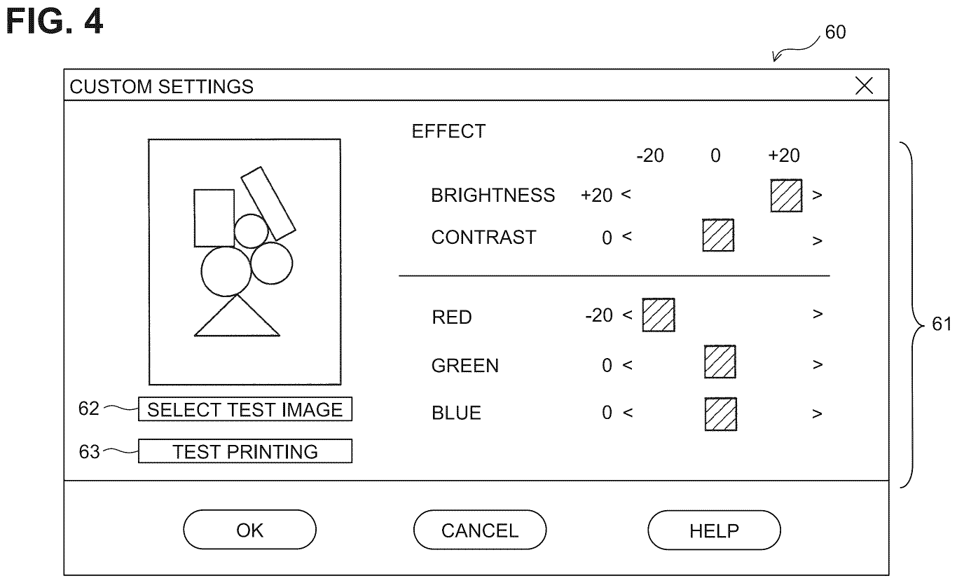

The supporting program 42 receives a user instruction related to test printing. The supporting program 42 causes the user IF 13 to display a custom settings screen 60 as shown in FIG. 4 for receiving a user instruction related to test printing. The custom settings screen 60 is an example of a settings screen.

The custom settings screen 60 shown in FIG. 4 includes a settings field 61 for each item of color balance, a test image selection button 62, and a test print execution button 63. The settings field 61 is a field for receiving various settings related to color balance. The items of color balance may include brightness, contrast, and saturation. Each item in the settings field 61 is an example of a specific item. The settings value received in each item of the settings field 61 is an example of a specific parameter.

The custom settings screen 60 is a screen for receiving settings in the settings field 61 for brightness, contrast, and color intensity of red, green, and blue. The supporting program 42 receives a settings value, that indicates a degree of separation from default setting, in a range of −20 to +20 for brightness, contrast, and color intensity in the settings field 61 of the custom settings screen 60. The supporting program 42 may further receive settings of saturation and color intensity of black.

The test image selection button 62 is a button for receiving selection of an image to be printed for test printing. Upon receiving an input to the test image selection button 62, the supporting program 42 receives selection of an image to be printed, i.e., test-print image selection, from various images stored in the PC 1. The supporting program 42 may download an image to be printed via the Internet.

The test print execution button 63 is a button for receiving a test print execution instruction, which is an instruction to print a default test image or a test image selected by the test image selection button 62, using the print settings in the settings field 61.

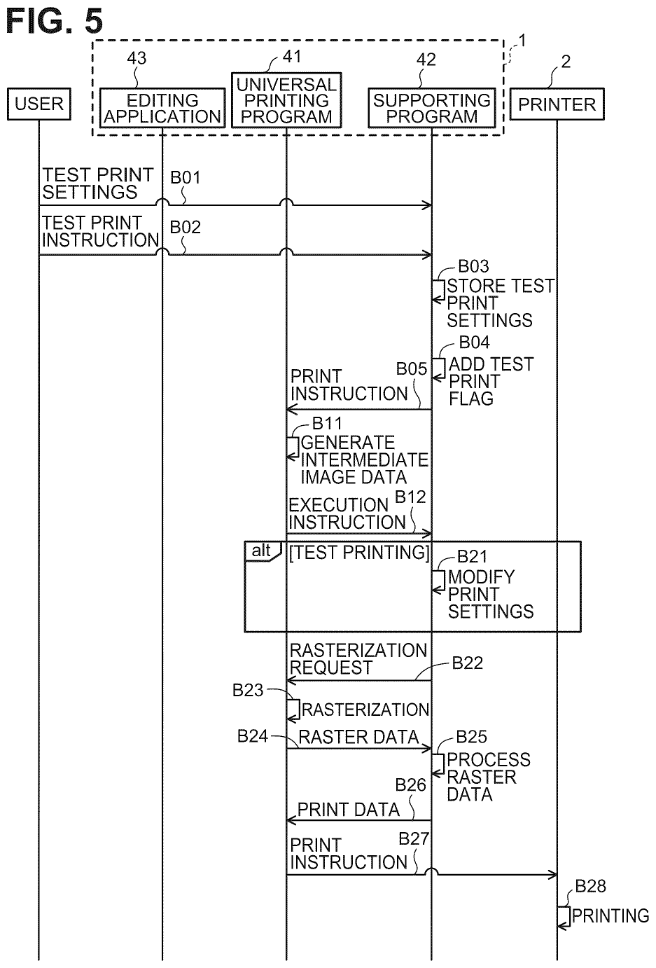

A test printing procedure will be described with reference to a sequence diagram in FIG. 5. A user sets a value of each item in the settings field 61 of the custom settings screen 60 shown in FIG. 4 (B01). Then, the user operates the test printing execution button 63 for test printing (B02). B01 and B02 are examples of reception processing. The user operation to the test printing execution button 63 is a test-print instruction.

The supporting program 42 stores in the memory 12 information on print settings, including settings related to test printing, i.e., test-print settings, based on a user operation to the test print execute button 63 (B03). The supporting program 42 adds information indicating test printing, i.e., test-print flag, to print instruction (B04), and passes the print instruction with the test printing information to the universal printing program 41 (B05). B05 is an example of input processing. The print instruction, i.e., test-print command, passed to the universal printing program 41 in B05 is an example of a test print instruction. In B05, the supporting program 42 passes image data indicating a selected test image and print settings to which information indicating test printing is added, to the universal printing program 41. The information indicating test printing is an example of test information.

In B05, the supporting program 42 inputs a print execution instruction to a print queue associated with the supporting program 42 provided by the universal printing program 41. The print execution instruction is the same as a later-described print instruction that the editing application 43 issues to the universal printing program 41 in normal printing procedure.

When the universal printing program 41 receives an instruction to execute printing in this print queue, the universal printing program 41 starts a procedure for causing the printer 2 to print. The universal printing program 41 generates intermediate image data based on image data indicating an image to be printed (B11), and launches the supporting program 42 (B12). The supporting program 42 requests to the universal printing program 41 and obtains intermediate image data, i.e., intermediate test-print image data, generated by the universal printing program 41. In this procedure, the image to be printed is a test image passed from the supporting program 42.

That is, when a print instruction associated with information indicating test printing is input, the universal printing program 41 generates intermediate image data indicating a test image which is an image to be printed and inputs the intermediate image data associated with information indicating test printing to the supporting program 42. However, the universal printing program 41 may not need to determine whether or not information indicating test printing is associated. The universal printing program 41 may generate intermediate image data and launch the supporting program 42 in the same manner as in normal printing procedure.

In response to an execution instruction received from the universal printing program 41, the supporting program 42 first determines whether or not the execution instruction is a test printing instruction to which information indicating test printing is added. In this sequence, the supporting program 42 adds information indicating test printing to the printing instruction in B04. Therefore, in B12, the supporting program 42 determines that the execution instruction is a test printing instruction based on information indicating test printing added in B04 to the print instruction.

If it is determined that the execution instruction is a test printing instruction (alt: [test print]), the supporting program 42 modifies print settings (B21). The supporting program 42 may overwrite print settings not related to test printing with default values. B21 is an example of overwriting processing.

The test printing is for checking color balance. If printed with settings unrelated to color balance, a user may have difficulty to check color balance of test image printed on a sheet. It would be preferable that the test printing is performed without settings unrelated to color balance, which may cause extra user-tasks, more time for printing, and/or waste consumables.

Specifically, the supporting program 42 overwrites settings, for scaling, i.e., enlarging or reducing, image with default value. For example, the supporting program 42 may set scaling magnification to 100% and may set consolidated printing to negative. The supporting program 42 also overwrites compositing-print settings with default value. For example, the supporting program 42 may set compositing-print settings to “No watermark” or “No header or footer”.

The supporting program 42 further overwrites settings for printing-more-than-a-single-page with default value. For example, the supporting program 42 may set settings for duplex printing to single-sided printing, and may set number of copies to a single copy. The supporting program 42 further overwrites settings that requires a user operation before printing with default value. For example, the supporting program 42 may set settings for preview to “No preview” and settings for storing-data-for-reprinting to “No reprinting”.

The supporting program 42 that overwrites some print settings, i.e., second setting value, for test printing with default value, i.e., particular setting value, may result in useful and appropriate test printing. An execution instruction from the universal printing program 41 based on a print instruction from the editing application 43 does not include information indicating test printing. When the supporting program 42 receives an execution instruction without information indicating test printing, the supporting program 42 does not execute B21. Printing procedure based on the print instruction from the editing application 43 will be described later.

The supporting program 42 passes the modified print settings and the intermediate image data to the universal printing program 41, and requests the universal printing program 41 to rasterize the intermediate image data (B22). The universal printing program 41 rasterizes the intermediate image data and generates raster data that is bitmap data (B23). The universal printing program 41 passes the generated raster data to the supporting program 42 (B24). In this way, the supporting program 42 obtains raster data. The raster data that the supporting program 42 obtains in A34 is raster data of a test image, and information indicating test printing is added to the raster data.

The supporting program 42 processes the obtained raster data based on the print settings of the test print, i.e., test-print settings (B25). B25 is an example of a first processing. The raster data that the universal printing program 41 generates is bitmap data in which each dot is represented with RGB values, i.e., R value, G value and B value. The supporting program 42 corrects the RGB values of each dot based on values of the print settings, i.e., first setting value, received in the settings field 61 of the custom settings screen 60 and stored in the memory 12 in B03. If brightness setting in the settings field 61 is “+20”, each of R value, G value and B value is increased for twenty (20). If the red setting in the settings field 61 is “−20”, the R value is decreased for twenty (20). The supporting program 42 may perform processing based on the print settings of the test print on the intermediate image data or on CMYK data obtained by converting RGB values into CMYK values.

The supporting program 42 encodes the processed raster data into PDL data to generate print data, i.e., test-print image data. The supporting program 42 passes the generated print data to the universal printing program 41 to instruct transmission to the printer 2 (B26). B26 is a process for causing the printer 2 to print a test image, and is an example of a test print process.

The universal printing program 41 transmits print data to the printer 2 in response to an instruction from the supporting program 42, and instructs the printer 2 to print the print data (B27). The printer 2 performs printing based on the received print data (B28). In this way, a test image according to the print settings of test printing is printed on a sheet.

The supporting program 42 passes the print data generated based on the raster data processed in B25 to the universal printing program 41 and instructs the universal printing program 41 to print the print data, so that a test image with modified color balance is printed. That is, the supporting program 42 causes test printing including print settings not supported by the universal printing program 41.

Even after the supporting program 42 receives the instruction for the test printing in B02, the supporting program 42 actively displays the custom settings screen 60 and receives a user operation to each button in the custom settings screen 60. Thus, a user may change print settings of the test printing and then instruct performing the test printing again.

Back to the procedure in FIG. 2, when the test printing is completed, the user may instruct to finish print settings by operating OK button on the custom settings screen 60. When the supporting program 42 receives an instruction to finish the advanced settings (A22), the supporting program 42 completes displaying the custom settings screen 60 and stores the received print settings in the memory 12 (A23).

The print settings stored in A23 includes each of the RGB values of the color balance in the settings field 61 of the custom settings screen 60. In B03 the supporting program 42 replaces the already-stored print settings to the print settings set when received the instruction in A22.

The supporting program 42 notifies the universal printing program 41 that the advanced print settings is completed (A25). The universal printing program 41 notifies the editing application 43 that the print settings based on the notification from the supporting program 42 is completed (A26). Instead, the supporting program 42 may notify the editing application 43 that the print settings is finished. The editing application 43 activates the print settings screen D2 displayed in A03 so that the editing application 43 can receive a user instruction such as an instruction to execute printing or an instruction to cancel printing.

As described above, the print settings screen D2 includes the information display field 52 for displaying an image generated by the supporting program 42. When the universal printing program 41 receives an operation to the information display field 52, the universal printing program 41 passes information about the operation to the supporting program 42. The supporting program 42 may display an information screen for receiving an instruction to execute test printing in the information display field 52, and may allow a user to input a user instruction to execute test printing in the information display field 52. The supporting program 42 executes test printing in the processes shown in FIG. 5 even when the supporting program 42 receives instructions through the information display field 52.

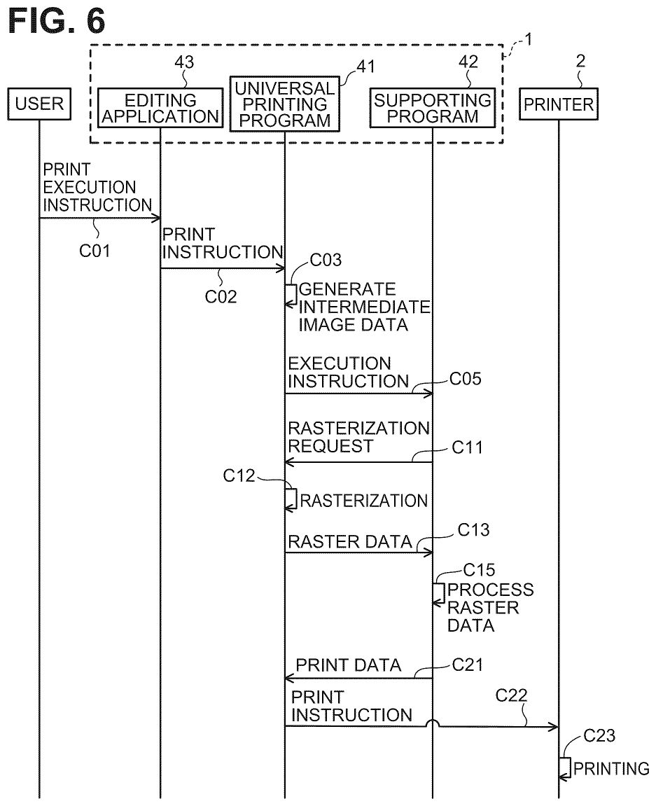

Next, a normal printing procedure will be described with reference to a sequence diagram of FIG. 6. After a user of the editing application 43 determines an image to be printed and print settings for the printer 2, the user inputs an instruction, i.e., print instruction, to execute printing in the editing application 43 (C01). When the editing application 43 receives a user operation to the print button 55 on the print settings screen D2, the editing application 43 determines that the editing application 43 has received an instruction to the universal printing program 41 to cause the printer 2 to print the determined image.

The editing application 43 passes information of the received instruction to the universal printing program 41 (C02). The universal printing program 41 obtains image data of an image to be printed and print settings from the editing application 43.

The universal printing program 41 generates intermediate image data by converting image data of an image to be printed into the intermediate image data based on the print settings obtained from the editing application 43 (C03). The image data included in the editing application 43 is of various types, and the universal printing program 41 converts the image data to be printed into intermediate image data suitable for generating print data. If the image data to be printed is suitable for generating print data, it may not be required to generate intermediate image data so that the image data to be printed may be intermediate image data.

Before the intermediate image data is generated, the universal printing program 41 may launch the supporting program 42 corresponding to the printer 2 to notify that processing of print job has been started. When the supporting program 42 is launched, the supporting program 42 may pass various instructions used when generating the intermediate image data to the universal printing program 41.

After generating the intermediate image data, the universal printing program 41 launches the supporting program 42 (C05). The supporting program 42 obtains the intermediate image data generated by the universal printing program 41 by requesting to the universal printing program 41. The intermediate image data input from the universal printing program 41 to the supporting program 42 in C05 is an example of intermediate data. The supporting program 42 edits the intermediate image data and the print settings received from the universal printing program 41 based on the received print settings. The supporting program 42 reads the print settings stored in A23 and edits the intermediate image data and the print settings.

In the print execution procedure in FIG. 6, unlike the test print procedure in FIG. 5, the universal printing program 41 passes the intermediate image data based on the print instruction received from the editing application 43 in C02 to the supporting program 42. Since this print instruction does not go through the procedure described in B04, the supporting program 42 does not perform modifying the print settings in B21, but applies the print settings stored in A23 as it is. If the print settings include a setting unrelated to the color balance, the supporting program 42 does not replace the unrelated setting.

The supporting program 42 passes the intermediate image data to the universal printing program 41 and requests the universal printing program 41 to rasterize the intermediate image data (C11). The universal printing program 41 rasterizes the intermediate image data and generates raster data that is bitmap data (C12). The universal printing program 41 then passes the generated raster data to the supporting program 42 (C13). In this way, the supporting program 42 obtains the raster data.

While the universal printing program 41 generates raster data in B22 to B24 and C11 to C13, the supporting program 42, instead of the universal printing program 41, may generate raster data. In this case, the supporting program 42 rasterizes the intermediate image data received in response to the print execution instruction. Rasterization by the supporting program 42 may achieve a greater flexibility than rasterization by the universal printing program 41 and is highly likely to generate raster data suitable for printing by the printer 2. On the other hand, rasterization by the universal printing program 41 requires less processing by the supporting program 42 and can reduce program size of the supporting program 42.

The supporting program 42 processes the raster data obtained in C13 based on the print settings (C15). C15 is an example of second processing. If the print settings include color balance received in the settings field 61 of the custom settings screen 60, the supporting program 42 corrects the RGB values of the bitmap data based on the print settings, as in the process of B25. The supporting program 42 encodes the processed raster data into PDL data to generate print data, i.e., print image data.

The supporting program 42 passes the generated print data to the universal printing program 41 and instructs the universal printing program 41 to transmit the print data to the printer 2 (C21). C21 is a process for causing the printer 2 to print the print data, and is an example of a print process.

The print data that the supporting program 42 passes to the universal printing program 41 in B26 or C21 may be in a format that can be printed by the printer 2. The PDL data generated by the supporting program 42 may be used for printing by a printer other than the printer 2.

The universal printing program 41 transmits print data to the printer 2 in response to an instruction from the supporting program 42, and instructs the printer 2 to print the print data (C22). The printer 2 executes printing based on the received print data (C23). Thus, the printer 2 prints an image corrected based on color balance set by the user.

In B26 and C21, the supporting program 42 passes the print data to the universal printing program 41 to transmit the print data to the printer 2. However, the supporting program 42 may transmit a print command and print data directly to the printer 2. The supporting program 42 may generate a print command including information on image processing that can be executed by the printer 2 when settings for the image processing are included in print settings. In this case, the supporting program 42 may notify the universal printing program 41 that transmission of the print data is completed.

As described above in detail, the supporting program 42 of the present embodiment receives print settings and an instruction to execute test printing via the custom settings screen 60, and when the instruction is given in a state where the setting for color balance is received, the supporting program 42 causes the printer to print a test image processed based on the setting. Thus, even in the PC 1 having the OS 21 with the universal printing program 41 and without a printer driver, test printing reflecting the print settings received on the custom settings screen 60 can be performed. Therefore, the time and effort of test printing are less than those in the case where printing is repeated by changing the default print settings.

Furthermore, the supporting program 42 of this embodiment causes the universal printing program 41 to execute in B22 to B28 for the test printing the same procedure as C11 to C23 for the normal printing. That is, the supporting program 42 executes processes for the test printing with the same procedure as the normal printing by passing a printing instruction for the test printing to the universal printing program 41. Therefore, the supporting program 42 does not include codes for the test printing, thus the supporting program 42 has a lighter workload.

The embodiments disclosed in the present specification are merely illustrative and are not intended to limit the present invention in any way. Therefore, the technology disclosed in the present specification can be naturally improved and modified in various ways without departing from the gist thereof. For example, the apparatus connected to the PC 1 is not limited to a printer, and may be any apparatus having a printing function, such as a multifunction peripheral, a copying machine, and a facsimile apparatus. The number of printers connected to the PC 1 is not limited to the example shown in the drawings, and may be two or more.

The screens shown on the user IF 13 are only examples and are not limited to the illustrated cases. The text, shapes of objects, backgrounds, and other elements on each screen may be of any design. For example, in FIG. 4, the custom settings screen 60 includes both the settings field 61 and the test print button 63 on a single screen, but these can also be provided on separate screens. Similarly, in FIG. 3, the print settings screen D2 includes one information display area 52, but the position, shape, size, and number of information display areas are not limited to this example. The information display area 52 may also be omitted.

In FIG. 4, the custom settings screen 60 includes a test image selection button 62, but selecting a test image is not required. The supporting program 42 may use a default test image or allow selection only from several stored test images. On the other hand, if any image can be selected as the test image, users have more options and greater flexibility in test printing.

The print settings available for test printing are not limited to color balance; any applicable print settings can be accepted. Overwriting parameters other than color balance is not necessary. However, for users who want to test color balance, using default values for other parameters makes it easier to evaluate the results. The supporting program 42 may also allow users to choose whether to temporarily reset parameters other than color balance.

If the printer 2 cannot perform color printing, e.g., if color printing is disabled via its control panel, the supporting program 42 may prohibit setting color balance. In such cases, the supporting program 42 may also reject instructions for test printing.

The timing at which the supporting program 42 obtains the capabilities data of the printer 2 is not limited to the example of FIG. 2. The supporting program 42 may request the capabilities data of the printer 2 when the supporting program 42 is launched by the universal printing program 41 before the print settings screen D2 is displayed. The supporting program 42 may obtain the capabilities data of the printer 2 again after receiving the print instruction.

After the print settings screen D2 is displayed by the universal printing program 41, if the default printer is changed from another printer to printer 2 via the OS 21 by user operation, the universal printing program 41 may also launch the supporting program 42. In this case, the supporting program 42 may display an information screen in the information display area 52 that allows receiving instructions related to test printing.

The supporting program 42 may be launched not only when printing is instructed, but also, when the printer 2 is selected as the device setting. In this case, the supporting program 42 may display a settings screen that allows settings for color balance. When color balance settings are received as a device setting, the supporting program 42 stores the received settings as default print settings.

In the embodiment, only the printing operation of the supporting program 42 is described in detail, but the supporting program 42 may also have other functions. The program that executes the processing of this embodiment is not limited to the supporting program 42; any program that can receive instructions from the OS 21 or the universal printing program 41 when printing using the universal printing program 41 may be used. Print workflow applications as specified by Microsoft may also be used.

The execution timing of the supporting program 42 is not limited to the example in the embodiment. The supporting program 42 may be executed directly by an instruction from the OS 21, or may be a resident program. If resident, the supporting program 42 may perform the above operations upon receiving an execution command.

In any flowcharts disclosed in the embodiments, the order of processes in any steps can be changed or executed concurrently as long as there is no conflict in the processes.

The processing disclosed in the embodiments may be executed by a single CPU, multiple CPUs, another hardware such as an ASIC, or a combination thereof. The processing may be implemented in various forms such as a recording medium storing a program for executing the processing, or a method for executing the processing.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

Wi-Fi is a registered trademark of Wi-Fi Alliance. macOS is a registered trademark of Apple Inc. Linux is a registered trademark of Linus Torvalds in the U.S. and other countries. IOS is a registered trademark of Cisco and is used under license. Android is a trademark of Google LLC. Microsoft Word, Microsoft PowerPoint, and Windows are trademarks of Microsoft group of companies.

What is claimed is:

1. A non-transitory computer-readable recording medium storing a support program including instructions that, when executed by a computer of an information processing apparatus, cause the computer to:
display a settings screen on a user interface of the information processing apparatus and execute an reception process that receives, via the settings screen, a print setting and an instruction to execute test printing;
wherein, when a specific parameter for a specific item of the print setting is received in the reception process and the instruction to execute test printing is received in the reception process, the computer is further caused to:
perform a first processing to process a test image, which is an image to be used for the test printing, in accordance with the specific parameter of the print setting received in the reception process; and
perform a test printing process to cause a printer to print the test image processed by the first processing;
wherein, when a print instruction output from an application program installed in the information processing apparatus is issued to cause a universal printing program of an operating system of the information processing apparatus to print an image on the printer, and intermediate data indicating the image to be printed according to the print instruction is input from the universal printing program to the support program, the computer is further caused to:
when the specific parameter is set for the specific item of the print setting for the print instruction, perform a second processing to process the image indicated by the intermediate data in accordance with the specific parameter in a manner similar to the first processing; and
perform a print processing to cause the printer to print the image processed by the second processing.

2. A non-transitory computer-readable recording medium of claim 1, wherein the instructions further cause the computer to:
when the instruction to execute test printing is received in the reception process, execute an input process to input, to the universal printing program, a test print instruction to cause the printer to print the test image, such that the test print instruction is input to the universal printing program and the universal printing program inputs, to the support program, intermediate data indicating the test image; and
when the intermediate data indicating the test image is input from the universal printing program, execute the first processing and the test printing process.

3. A non-transitory computer-readable recording medium of claim 2, wherein, in the input process,
the computer is further caused to input, to the universal printing program, the print instruction to cause the printer to print the test image, wherein test information indicating that the print instruction is for test printing is associated with the print instruction, and the universal printing program, when the print instruction associated with the test information is input, inputs, to the support program, the intermediate data indicating the test image and associated with the test information;
wherein, when the intermediate data associated with the test information is input from the universal printing program, the computer is further caused to execute the first processing and the test printing process; and
when the intermediate data not associated with the test information is input from the universal printing program, the computer is further caused to execute the second processing and the print processing.

4. A non-transitory computer-readable recording medium of claim 1, the instructions further cause the computer to:
when the instruction to execute test printing is received in the reception process,
perform an overwriting process to overwrite at least part of the print setting other than the specific item among a plurality of items included in the print setting with default parameters for test printing;
perform the first processing to process the test image in accordance with the specific parameter of the print setting received in the reception process and the default parameters of the print setting overwritten by the overwriting process; and
perform the test printing process to cause the printer to print the test image processed by the first processing in accordance with the print setting overwritten by the overwriting process.

5. A non-transitory computer-readable recording medium of claim 4, wherein:
among the plurality of items of the print setting, the specific item includes an item relating to color balance;
among the plurality of items of the print setting, an item relating to enlargement or reduction of the image to be printed is included as an item to be overwritten by the overwriting process; and
in the overwriting process, the item relating to enlargement or reduction of the image to be printed is overwritten with a parameter indicating neither enlargement nor reduction.

6. A non-transitory computer-readable recording medium of claim 4, wherein:
among the plurality of items of the print setting, the specific item includes an item relating to color balance;
among the plurality of items of the print setting, an item relating to compositing predetermined data onto the image to be printed is included as an item to be overwritten by the overwriting process; and
in the overwriting process, the item relating to compositing predetermined data onto the image to be printed is overwritten with a parameter indicating that the predetermined data is not composited.

7. A non-transitory computer-readable recording medium of claim 1, wherein:
among the items of the print setting, the specific item includes at least one of brightness, contrast, and saturation as color balance items; and
in the first processing, the test image is corrected in accordance with the specific parameter of the color balance received in the reception process.

8. A non-transitory computer-readable recording medium of claim 1, the instructions further cause the computer to:
in the reception process, the settings screen is displayed on the user interface of the information processing apparatus, and, via the settings screen, the print setting, the instruction to execute test printing, and selection of the test image are received; and
in the first processing, the test image received in the reception process is processed in accordance with the specific parameter of the print setting received in the reception process.

9. A non-transitory computer-readable recording medium of claim 1, wherein:
the specific item of the print setting is an item not supported by the universal printing program.

10. A non-transitory computer-readable recording medium storing a support program including instructions that, when executed by a computer, cause the computer to perform processes comprising:
displaying a settings screen;
receiving a test-print setting via the settings screen;
receiving a test print execution instruction via the settings screen;
generating test-print image data based on the test-print setting;
transmitting the test-print image data for printing;
receiving a print instruction from a universal printing program;
receiving intermediate image data from the universal printing program;
generating print image data based on the intermediate image data using a print setting; and
transmitting the print image data for printing.

11. The non-transitory computer-readable recording medium of claim 10, wherein the instructions cause the computer to perform the processes, the processes further comprising:
outputting a test-print command to the universal printing program in response to receiving the test-print instruction; and
receiving intermediate test-print data from the universal printing program,
wherein the test-print image data is generated based on the intermediate test-print data using the test-print setting.

12. The non-transitory computer-readable recording medium of claim 11, wherein the received intermediate test-print data includes a test-print flag.

13. The non-transitory computer-readable recording medium of claim 10, wherein the received intermediate image data does not include a test-print flag.

14. The non-transitory computer-readable recording medium of claim 10, wherein:
the test-print setting includes a first setting value and a second setting value;
the second setting value is replaced with a particular setting value; and
the test-print image data is generated based on the first setting value and the particular setting value.

15. The non-transitory computer-readable recording medium of claim 14, wherein the first setting value is related to color balance.

16. The non-transitory computer-readable recording medium of claim 15, wherein:
the second setting value is related to scaling image, and
the particular setting value represents non-scaling.

17. The non-transitory computer-readable recording medium of claim 16, wherein:
the second setting value is related to compositing, and
the particular setting value represents non-compositing.

18. The non-transitory computer-readable recording medium of claim 10, wherein:
the test-print setting includes brightness, contrast, or saturation, and
the generated test-print image data is corrected image data based on the test-print setting.

19. The non-transitory computer-readable recording medium of claim 10, wherein the instructions cause the computer to perform the processes, the processes further comprising: comprising:
receiving a test-print image selection via the setting screen; and
generating the test-print image data based on the test-print image selection and the test-print setting.

20. The non-transitory computer-readable recording medium of claim 11, wherein the test-print image data is encoded before transmitted.
